(19) United States
(12) Patent Application Publication
(10) Pub. No.: US 2007/0257874 A1
(43) Pub. Date: Nov. 8, 2007

(54) LIQUID CRYSTAL DISPLAY, IMAGE SIGNAL CORRECTION METHOD, AND METHOD OF DRIVING LIQUID CRYSTAL DISPLAY

(75) Inventor: Jong-Woo KIM, Anyang-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/566,920

(22) Filed: Dec. 5, 2006

(30) Foreign Application Priority Data
Dec. 14, 2005 (KR) 10-2005-0123135

(51) Int. Cl. G09G 3/36

(52) U.S. Cl. 345/89

(57) ABSTRACT

A liquid crystal display includes; a plurality of pixels which have first and second subpixels, an image signal correction unit which generates a preliminary signal based on a previous image signal and a current image signal, generates corrected image signal based on the preliminary signal and a next image signal, and generates an enable signal and a synchronization signal, a first circuit which calculates a logical product of the enable signal and the synchronization signal and outputs the logical product as a corrected information signal, a second circuit which calculates a logical sum of the corrected information signal and a pixel information signal and outputs the logical sum as a result signal, and a gray voltage generator which generates first or second gray voltage sets which differ from each other.

This application claims priority to Korean Patent Application No. 10-2005-0123135, filed on Dec. 14, 2005, and all the benefits accruing therefrom under 35 U.S.C. § 119, the contents of which in its entirety are herein incorporated by reference.

### BACKGROUND OF THE INVENTION

(a) Field of the Invention

The present invention relates to a liquid crystal display, an image signal correction method, and a method of driving a liquid crystal display.

(b) Description of the Related Art

Liquid crystal displays are now the most widely used flat panel displays. The liquid crystal displays have two display panels on which electric field generating electrodes such as pixel electrodes and a common electrode are formed, and a liquid crystal layer which is interposed between the panels. In the liquid crystal displays, a voltage is applied to the electric field generating electrodes so as to generate an electric field, and then the alignment of liquid crystal molecules of the liquid crystal layer is determined by the electric field. Accordingly, the polarization of incident light is controlled by the liquid crystal molecules, thereby selectively allowing light to pass therethrough. An image may then be formed by assembling a plurality of pixels, each of which may selectively transmit light therethrough.

The liquid crystal displays also include switching elements connecting the individual pixel electrodes and a plurality of signal lines, such as gate lines and data lines, for controlling the switching elements so as to apply voltages to the pixel electrodes.

Among the liquid crystal displays, a vertical alignment (“VA”) mode liquid crystal display, in which major axes of liquid crystal molecules are arranged in a vertical direction with respect to the upper and lower display panels in a state where the electric field is not applied, is attracting more attention since it has a large contrast ratio and a wide reference viewing angle. Here, the reference viewing angle means a viewing angle with a contrast ratio of about 1:10 or a luminance inversion maximum angle between gray levels.

In the VA mode liquid crystal display, there are two dominant means for achieving a wide viewing angle; the first is a method of forming cutouts in the field generating electrodes, and the second is a method of forming protrusions on the field generating electrodes. The inclination directions of the liquid crystal molecules can be determined with the cutouts or the protrusions. Then, the reference viewing angle can be widened by dispersing the inclination directions of the liquid crystal molecules in various directions.

Further, there has been suggested a method which, in order to improve the lateral visibility, divides one pixel into two subpixels, capacitively couples the two subpixels, and directly applies a voltage to one subpixel. Then, a voltage drop is caused in the other subpixel by capacitive coupling, such that the voltages of the two subpixels are different from each other, thereby varying transmittance.

Meanwhile, liquid crystal displays are widely being used as a display device for computers and a display screen for televisions, and thus a demand for display of motion pictures is increasing. However, since the liquid crystal displays have a relatively low response speed due to the relatively slow response of the liquid crystal, it is difficult to display motion pictures.

Accordingly, in order to compensate for the low response speed of liquid crystal, there has been developed a method which applies a data voltage (overshoot voltage or undershoot voltage) which is higher or lower than a data voltage corresponding to an input image signal to the pixel electrode. The principle behind this method is that by applying a higher voltage than the voltage which would be required to achieve a certain displacement of the liquid crystals the liquid crystals reach the desired displacement in a smaller amount of time. Similarly, a lower voltage than the voltage required to achieve a certain displacement of the liquid crystals may be applied in order to reach the desired displacement in a smaller amount of time. For example, if it would normally take 5 volts to twist the liquid crystals to the desired transmittance level a voltage of 10 volts may be applied in order to rapidly twist the liquid crystals to the desired transmittance level; and if the liquid crystals are already at a transmittance level corresponding to 10 volts and the desired transmittance is that corresponding to the 5 volt level a voltage of 0 volts may be applied in order to rapidly untwist the liquid crystals to the desired transmittance level.

However, in a liquid crystal display having two subpixels, the two subpixels have different gamma curves illustrating a pixel's transmittance. In the gamma curve of the subpixel having a relatively low voltage, since a change in voltage with respect to a predetermined change in gray level at a lower gray level is small, when an overshoot voltage is applied, it is not easy to compensate for the low response speed of liquid crystal.

Accordingly, the present invention seeks to correct these deficiencies.

### BRIEF SUMMARY OF THE INVENTION

An exemplary embodiment of the present invention provides a liquid crystal display including; a plurality of pixels which have first and second subpixels, respectively, an image signal correction unit which generates a preliminary signal based on a previous image signal and a current image signal, generates a corrected image signal based on the preliminary signal and a next image signal, and generates an enable signal and a synchronization signal, a first circuit which calculates a logical product of the enable signal and the synchronization signal and outputs the logical product as a corrected information signal, a second circuit which calculates a logical sum of the corrected information signal and a pixel information signal and outputs the logical sum as a result signal, and a gray voltage generator which generates first or second gray voltage sets which differ from each other. The corrected image signal is applied to the plurality of pixels when the enable signal is “1” and the corrected image signal is not applied to the plurality of pixels when the enable signal is “0”. The corrected image signal is applied to the plurality of pixels when the synchronization signal is “1” and the corrected image signal is not applied to the plurality of pixels when the synchronization signal is “0”. The corrected image signal is applied to the first subpixels when the pixel information signal is “1” and the corrected image signal is applied to the second subpixels when the pixel information signal is “0”. The first gray voltage set is selected when the result signal is “1”, and the second gray voltage set is selected when the result signal is “0”. The first gray voltage set has a higher potential than the second gray voltage set at substantially the same gray.

The liquid crystal display according to the exemplary embodiment of the present invention may further include a data driver which selects a gray voltage from the gray voltage generator, changes the corrected image to a data voltage, and applies the data voltage to one of the first subpixel and the second subpixel.

The first subpixel may include a first thin film transistor and the second subpixel may include a second thin film transistor.

The liquid crystal display according to the exemplary embodiment of the invention may further include a first gate line connected to the first thin film transistor, a second gate line connected to the second thin film transistor, and a data line connected to the first and second thin film transistors.

The pixel information signal is applied from a signal controller and may include a selection signal (“SE”) which is applied to the gray voltage generator.

A difference between the preliminary signal and the previous image signal may be equal to or more than a difference between the current image signal and the previous image signal.

The image signal correction unit may include a first frame memory which stores the previous image signal and a second frame memory which stores the current image signal, and a lookup table which stores a reference preliminary signal which is based on the previous image signal and the current image signal.

The first frame memory and the second frame memory may be formed as a singular frame memory.

The image signal correction unit may interpolate the reference preliminary signal and generate the preliminary signal based on the interpolation of the reference preliminary signal.

A period in which the synchronization signal is “1” may be one or two frames.

An area of the first subpixel may be smaller than an area of the second subpixel.

A data voltage applied to the first subpixel may be higher than a data voltage applied to the second subpixel.

Another embodiment of the present invention provides an image signal correction method of a liquid crystal display including first and second subpixels; the image signal correction method including; generating a preliminary signal on the basis of a previous image signal and a current image signal, and generating a corrected image signal on the basis of the preliminary signal and a next image signal, generating a synchronization signal which synchronizes an enable signal of the corrected image signal and the corrected image signal, calculating a logical product of the enable signal and the synchronization signal to generate a corrected information signal, calculating a logical sum of the corrected information signal and a pixel information signal to generate a result signal, and generating a first gray voltage set or a second gray voltage set according to the result signal. The corrected image signal is applied when the enable signal is “1” and the corrected image signal is not applied when the enable signal is “0”. The corrected image signal is applied when the synchronization signal is “1” and the corrected image signal is not applied when the synchronization signal is “0”. The corrected image signal is applied to the first subpixel when the pixel information signal is “1” and the corrected image signal is applied to the second subpixel when the pixel information signal is “0” when the corrected image signal is applied to the second subpixel. The first gray voltage set is selected when the result signal is “1” and the second gray voltage set is selected when the result signal is “0”. The first gray voltage set has a higher potential than the second gray voltage set at substantially the same gray.

Another exemplary embodiment of the present invention provides a method of driving a liquid crystal display including first and second subpixels, the method including; comparing a previous image signal, a current image signal, and a next image signal, and generating and outputting a corrected image signal according to the comparison result, comparing the previous image signal, the current image signal, and the next image signal and outputting the current image signal according to the comparison result, generating a first data voltage and a second data voltage corresponding to the corrected image signal when the corrected image signal is output, generating a third data voltage and a fourth data voltage corresponding to the current image signal when the corrected image signal is output, applying the first data voltage to the first subpixel and the second subpixel when the corrected image signal is output, and applying the third data voltage to the first subpixel and applying the fourth data voltage to the second subpixel when the current image signal is output.

The first data voltage may be higher than the second data voltage and the third data voltage may be higher than the fourth data voltage.

### DESCRIPTION OF THE DRAWINGS

The above and/or other aspects, features and advantages of the present invention will become apparent and more readily appreciated from the following description of the exemplary embodiments, taken in conjunction with the accompanying drawings of which:

FIG. 1 is a block diagram of an exemplary embodiment of a liquid crystal display according to the present invention;

FIG. 2 is an equivalent circuit diagram of an exemplary embodiment of two subpixels in an exemplary embodiment of a liquid crystal display according to the present invention;

FIG. 3 is an equivalent circuit diagram of an exemplary embodiment of one pixel in an exemplary embodiment of a liquid crystal panel assembly according to the present invention;

FIG. 4 is a top plan layout view of an exemplary embodiment of a liquid crystal panel assembly according to the present invention;

FIG. 5 is a cross-sectional view of an exemplary embodiment of a liquid crystal panel assembly shown in FIG. 4 taken along the line V-V′ and continuing along V′-V″;

FIGS. 6A, 6B, and 6C are top plan views of exemplary embodiments of electrode pieces and a base electrode forming a subpixel electrode according to the present invention.

FIG. 7 is a block diagram of an exemplary embodiment of an image signal correction unit in an exemplary embodiment of a liquid crystal display according to the present invention.

FIG. 8 is a flowchart showing an example of the operation of the exemplary embodiment of an image signal correction unit shown in FIG. 7.

FIG. 9 is a schematic view illustrating an exemplary embodiment of an image signal correction method according to the present invention.

FIG. 10 is a waveform chart showing an exemplary embodiment of a corrected signal according to the present invention.

FIG. 11 is a block diagram schematically showing an exemplary embodiment of a driving apparatus for an exemplary embodiment of a liquid crystal display according to the present invention.

FIG. 12 is a diagram showing waveforms of an exemplary embodiment of a driving signal in an exemplary embodiment of a liquid crystal display according to the present invention.

FIG. 13 is a diagram showing the operation of an exemplary embodiment of a logical AND circuit in the exemplary embodiment of a driving apparatus of a liquid crystal display of FIG. 11.

FIG. 14 is a diagram showing the operation of an exemplary embodiment of a logical OR circuit in the exemplary embodiment of a driving apparatus of a liquid crystal display of FIG. 11.

FIG. 15 is a graph showing a change in luminance according to gray levels in an exemplary embodiment of a liquid crystal display according to the present invention.

FIG. 16 is a block diagram schematically showing another exemplary embodiment of a driving apparatus of an exemplary embodiment of a liquid crystal display according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

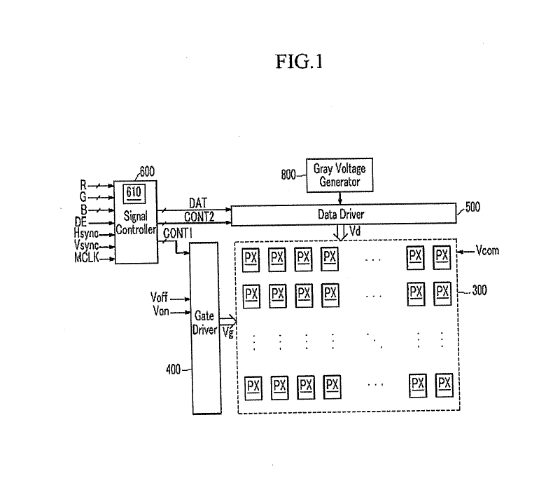

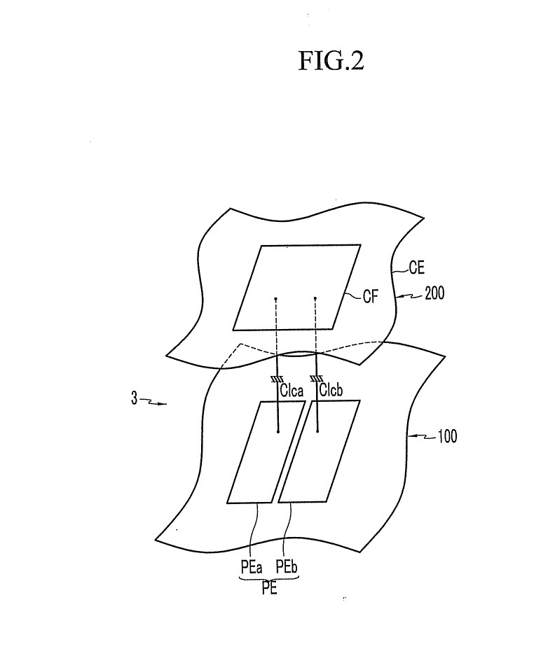

First, a liquid crystal display according to an exemplary embodiment of the present invention will be described in detail with reference to FIGS. 1 and 2.

FIG. 1 is a block diagram of an exemplary embodiment of a liquid crystal display according to the present invention, and FIG. 2 is an equivalent circuit diagram of an exemplary embodiment of two subpixels in an exemplary embodiment of a liquid crystal display according to the present invention.

As shown in FIG. 1, an exemplary embodiment of a liquid crystal display according to the present invention includes a liquid crystal panel assembly 300, a gate driver 400 and a data driver 500 which are connected to the liquid crystal panel assembly 300, a gray voltage generator 800 which is connected to the data driver 500, and a signal controller 600 which controls the gate driver 400, the data driver 500, and the gray voltage generator 800.

The liquid crystal panel assembly 300 includes a plurality of signal lines (not shown), and a plurality of pixels PX which are connected to the plurality of signal lines and are arranged in an approximate matrix shape. Meanwhile, referring to the equivalent circuit diagram of FIG. 2, the liquid crystal panel assembly 300 includes lower and upper display panels 100 and 200 which face each other, and a liquid crystal layer 3 which is interposed between the lower and upper display panels 100 and 200.

The signal lines include a plurality of gate lines (not shown) which transmit gate signals (also referred to as “scanning signals”), and a plurality of data lines (not shown) which transmit data signals. The gate lines extend substantially in a row direction, substantially parallel to each other, and the data lines extend substantially in a column direction, substantially parallel to each other.

Each of the pixels PX includes a pair of subpixels, and the subpixels include liquid crystal capacitors Clca and Clcb, respectively. At least one of the two subpixels includes a switching element (not shown) which is connected to the gate line, the data line, and the liquid crystal capacitor Clca or Clcb.

A liquid crystal capacitor Clca/Clcb has a subpixel electrode PEa/PEb of the lower display panel 100 and a common electrode CE of the upper display panel 200 as two terminals, and the liquid crystal layer 3 between the subpixel electrode PEa/PEb and the common electrode CE serves as a dielectric material. A pair of subpixel electrodes PEa and PEb are separated from each other and together form one pixel electrode PE. The common electrode CE is supplied with a common voltage Vcom and covers substantially an entire surface of the upper panel 200. The liquid crystal layer 3 has negative dielectric anisotropy, and liquid crystal molecules of the liquid crystal layer 3 may be aligned such that their major axes are vertical to the surfaces of the two display panels in absence of an electric field.

Meanwhile, in one exemplary embodiment, in order for the liquid crystal display to display colors, each pixel PX uniquely displays one of a set of primary colors (spatial division) or each pixel PX temporally and alternately displays a plurality of primary colors (temporal division). Then, the primary colors are spatially and temporally synthesized, and thus a desired color is recognized. Exemplary embodiments of the primary colors include three primary colors of red, green, and blue. FIG. 2 shows an example of the spatial division. In FIG. 2, each pixel PX has a color filter CF which represents one of the primary colors in a region of the upper panel 200. Alternative exemplary embodiments include configurations wherein the color filter CF may be formed above or below the subpixel electrode PEa or PEb of the lower display panel 100.

Polarizers (not shown) are provided on outer surfaces of the display panels 100 and 200.

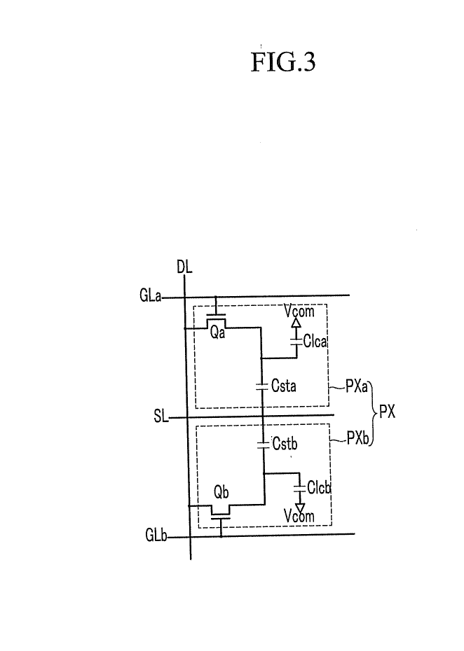

An example of an exemplary embodiment of a liquid crystal panel assembly according to the present invention will now be described in detail with reference to FIGS. 3 to 6C, along with FIGS. 1 and 2.

FIG. 3 is an equivalent circuit diagram of an exemplary embodiment of one pixel in an exemplary embodiment of a liquid crystal panel assembly according to the present invention.

Referring to FIG. 3, the exemplary embodiment of a liquid crystal panel assembly according to the present invention includes signal lines having a plurality of pairs of gate lines GLa and GLb, a plurality of data lines DL, and a plurality of storage electrode lines SL, and a plurality of pixels PX which are connected to the signal lines. The gate lines GLa and GLb are but a pair of a plurality of gate lines numbered G1 through Gn wherein n is a positive integer.

Each of the pixels PX includes a pair of subpixels PXa and PXb. Each subpixel PXa/PXb includes a switching element Qa/Qb which is connected to a corresponding gate line GLa/GLb and a corresponding data line DL, a liquid crystal capacitor Clca/Clcb which is connected to the switching element Qa/Qb, and a storage capacitor Csta/Cstb which is connected to the switching element Qa/Qb and a corresponding storage electrode line SL. The data lines DL is but one of a plurality of gate lines numbered D1 through Dm wherein m is a positive integer.

The switching element Qa/Qb is a three terminal element, such as a thin film transistor (“TFT”) and is provided on the lower display panel 100. The switching element Qa/Qb has three terminals: a control terminal of the switching element Qa/Qb is connected to the gate line GLa/GLb, an input terminal thereof is connected to the data line DL, and an output terminal thereof is connected to the liquid crystal capacitor Clca/Clcb and the storage capacitor Csta/Cstb.

The storage capacitor Csta/Cstb is an auxiliary capacitor for the LC capacitor Clca/Clcb, and is formed by overlapping the storage electrode line SL provided in the lower display panel 100 and the pixel electrode PE with an insulator interposed therebetween. A predetermined voltage, such as the common voltage Vcom, is applied to the storage electrode line SL. Alternatively, the storage capacitor Csta/Cstb includes the subpixel electrode and an adjacent gate line, called a previous gate line, which overlaps the pixel electrode Csta/Cstb via an insulator.

The liquid crystal capacitor Clca or Clcb has been described above, and thus a detailed description thereof will be omitted.

In an exemplary embodiment of a liquid crystal display having such a liquid crystal panel assembly, the signal controller 600 can receive input image signals R, G, and B from an external source (not shown) for one pixel PX, convert them into output image signals DAT for the two subpixels PXa and PXb, and transmit the output image signals DAT to the data driver 500. In an alternative exemplary embodiment, the gray voltage generator 800 generates separate groups of gray voltages for two subpixels PXa and PXb. The two groups of gray voltages are alternately supplied by the gray voltage generator 800 to the data driver 500 or alternately selected by the data driver 500 such that the two subpixels PXa and PXb are supplied with different voltages. At this time, the values of the converted output image signals and the values of the gray voltages in each group are preferably determined such that the synthesis of gamma curves for the two subpixels PXa and PXb approaches a reference gamma curve, the reference gamma curve being a gamma curve taken from a view in front of the display. For example, a synthesized gamma curve at a front view coincides with the most suitable reference gamma curve at a front view, and the synthesized gamma curve at a lateral view is the most similar to the reference gamma curve at a front view.

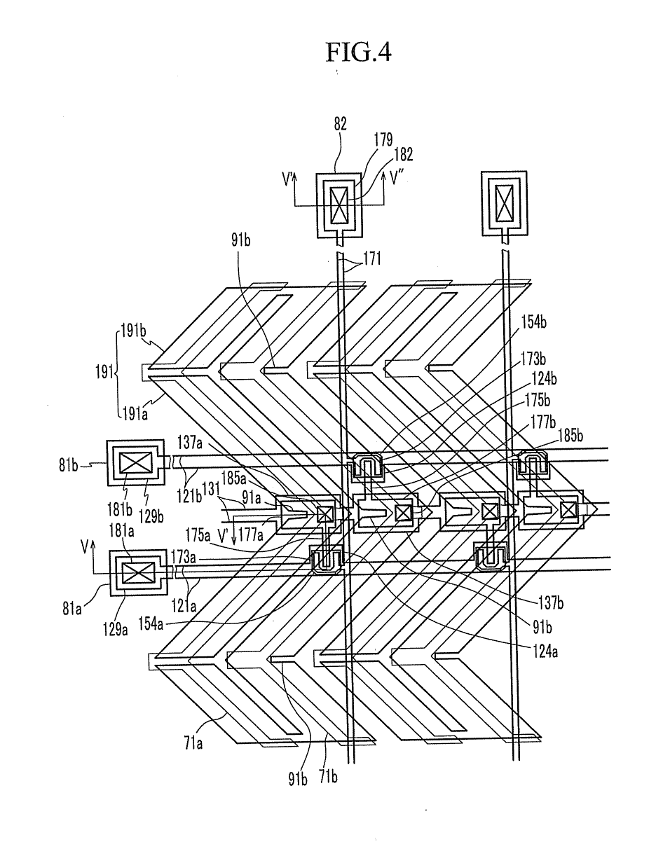

An example of the liquid crystal panel assembly shown in FIG. 3 will be described in detail with reference to FIGS. 4, 5, 6A, 6B, and 6C.

FIG. 4 is a top plan layout view of an exemplary embodiment of a liquid crystal panel assembly according to the present invention, and FIG. 5 is a cross-sectional view of the exemplary embodiment of a liquid crystal panel assembly shown in FIG. 4 taken along the line V-V′ and V′-V″.

Referring to FIGS. 4 and 5, the exemplary embodiment of a liquid crystal panel assembly according to the present invention includes a lower display panel 100 and an upper display panel 200 which face each other and a liquid crystal layer 3 which is interposed between the two display panels 100 and 200.

First, the lower display panel 100 will be described.

A plurality of gate conductors including a plurality of pairs of first and second gate lines 121a and 121b and a plurality of storage electrode lines 131 are formed on an insulation substrate 110. One exemplary embodiments of the insulation substrate is formed of transparent glass or plastic.

The first and second gate lines 121a and 121b transmit the gate signals, extend substantially in a lateral direction, and are positioned on lower and upper sides of the storage electrode line 131, respectively.

The first gate line 121a includes a plurality of first gate electrodes 124a which protrude upward and end portions 129a having wide area for connection to a different layer or the gate driver 400. The second gate line 121b includes a plurality of the second gate electrodes 124b which protrude downward and end portion 129b having wide area for connection to a different layer or the gate driver 400. In the alternative exemplary embodiment when the gate driver 400 is integrated on the substrate 110, the gate lines 121a and 121b may extend to be directly connected to the gate driver 400.

The storage electrode lines 131 are supplied with a predetermined voltage, such as the common voltage Vcom or the like, and also extend substantially in the lateral direction. Each of the storage electrode lines 131 is positioned between the first gate line 121a and the second gate line 121b, and is spaced by substantially the same distance between the two gate lines 121a and 121b. Each of the storage electrode lines 131 includes a plurality of pairs of first and second storage electrodes 137a and 137b which expand downward and upward from the electrode line. However, the shapes and arrangement of the storage electrodes 137a and 137b and the storage electrode lines 131 can be modified in various forms.

Exemplary embodiments of the gate conductors 121a, 121b, and 131 may be formed of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), and titanium (Ti). In alternative exemplary embodiments, the gate conductors may have a multilayer structure including two conductive layers (not shown) having different physical properties. In such an alternative exemplary embodiment, one conductive layer is formed of a metal having low resistivity, such as an aluminum-based metal, a silver-based metal, or a copper-based metal, in order to reduce signal delay or voltage drop. The other conductive layer is formed of a different material, particularly a material having excellent physical, chemical, and electrical contact characteristics with indium tin oxide (“ITO”) and indium zinc oxide (“IZO”), exemplary embodiments of such materials include a molybdenum-based metal, chromium, titanium, or tantalum.

Specific exemplary embodiments of the combination include a combination of a chromium lower layer and an aluminum (alloy) upper layer, and a combination of an aluminum (alloy) lower layer and a molybdenum (alloy) upper layer. The gate conductors 121a, 121b, and 131 may be formed of various metals or conductors, other than the above materials.

The lateral sides of the gate conductors 121a, 121b, and 131 are inclined with respect to a surface of the substrate 110, and according to one exemplary embodiment the inclination angle is preferably in a range of about 30° to about 80°.

A gate insulating layer 140 formed of silicon nitride (“SiNₓ”) or silicon oxide (“SiOₓ”) is formed on the gate conductors 121a, 121b, and 131.

A plurality of first semiconductor islands 154a and second semiconductor islands 154b formed of hydrogenated amorphous silicon (referred to as a-Si) or polysilicon are formed on the gate insulating layer 140. The first and second semiconductors 154a and 154b are positioned on the first and second gate electrodes 124a and 124b, respectively.

A pairs of ohmic contact islands 163a and 165a are formed on each of the first semiconductors 154a, and a pair of ohmic contact islands (not shown) is formed on each of the second semiconductors 154b. Exemplary embodiments of the ohmic contacts 163a and 165a may be formed of a material such as n+ hydrogenated amorphous silicon, in which an n-type impurity is doped with a high concentration, or silicide.

The lateral sides of exemplary embodiments of the semiconductor islands 154a and 154b and the ohmic contacts 163a and 165a are also inclined with respect to the surface of the substrate 110, and the inclination angle is in a range of about 30° to about 80°.

A plurality of data conductors including a plurality of data lines 171 and a plurality of pairs of first and second drain electrodes 175a and 175b are formed on the ohmic contacts 163a and 165a and the gate insulating layer 140.

The data lines 171 transmit data signals, extend substantially in the longitudinal direction, and cross the gate lines 121a and 121b and the storage electrode lines 131. Each of the data lines 171 includes a plurality of pairs of first and second source electrodes 173a and 173b which respectively extend toward the first and second gate electrodes 124a and 124b, and a wider end portion 179 for connection to a different layer or the data driver 500. In the exemplary embodiment wherein the data driver 500 is integrated on the substrate 110, the data lines 171 may extend to be directly connected to the data driver 500.

The first and second drain electrodes 175a and 175b are separated from each other and are separated from the data lines 171.

The first/second drain electrode 175a/175b faces the first/second source electrode 173a/173b with the first/second gate electrode 124a/124b centered thereabove. The first/second drain electrode 175a/175b includes one wider end portion 177a/177b and one bar-shaped end portion. The wider end portions 177a and 177b respectively overlap the first and second storage electrodes 137a and 137b, and the bar-shaped end portion is partially surrounded by curved portions of the first and second source electrodes 173a and 173b.

The first/second gate electrode 124a/124b, the first/second source electrode 173a/173b, and the first/second drain electrode 175a/175b together with the first/second semiconductor 154a or 154b, respectfully, form a first/second TFT Qa/Qb. A channel of the first/second thin film transistor Qa/Qb is formed in the first/the second semiconductor (154a/154b) between the first/second source electrode 173a/173b and the first/second drain electrode 175a/175b.

In one exemplary embodiment the data conductors 171, 175a, and 175b are formed of a refractory metal such as molybdenum, chromium, tantalum, and titanium, or an alloy thereof. In an alternative exemplary embodiment the data conductors 171, 175a, and 175b may have a multilayer structure of a refractory metal layer (not shown) and a low-resistance conductive layer (not shown). Specific exemplary embodiments of the multilayer structure includes a two-layer structure of a chromium or molybdenum (alloy) lower layer and an aluminum (alloy) upper layer, and a three-layer structure of a molybdenum (alloy) lower layer, an aluminum (alloy) intermediate layer, and a molybdenum (alloy) upper layer. However, the data conductors 171, 175a, and 175b may be formed of various metals or conductors, other than the above materials.

In one exemplary embodiment the data conductors 171, 175a and 175b have inclined edge profiles, and the inclination angles thereof range from about 30° 80°.

The ohmic contacts 163a and 165a are provided between the underlying semiconductors 154a and 154b and the overlying data conductors 171, 175a, and 175b so as to reduce contact resistance therebetween. The semiconductors 154a and 154b have exposed portions, which are not covered with the data conductors 171, 175a, and 175b, including portions between the source electrodes 173a and 173b and the drain electrodes 175a and 175b.

A passivation layer 180 is formed on the data conductors 171, 175a, and 175b and the exposed semiconductors 154a and 154b. Exemplary embodiments of the passivation layer 180 are formed of an inorganic insulator or an organic insulator, and the surface of the passivation layer 180 may be planarized. In one exemplary embodiment the organic insulator has a dielectric constant of about 4.0 or less, and it may have photosensitivity. Alternative exemplary embodiments of the passivation layer 180 may have a two-layer structure of a lower inorganic layer and an upper organic layer so as to use excellent insulating characteristics of an organic layer and to prevent the exposed portions of the semiconductors 154a and 154b from being damaged.

A plurality of contact holes 182, 185a, and 185b are formed in the passivation layer 180 which expose the end portion 179 of the data line 171, and the wider end portions 177a and 177b of the first and second drain electrodes 175a and 175b, respectively. Further, a plurality of contact holes 181a and 181b are formed in the passivation layer 180 and the gate insulating layer 140 which expose the end portions 129a and 129b of the gate lines 121a and 121b, respectively.

A plurality of pixel electrodes 191 and a plurality of contact assistants 81a, 81b, and 82 are formed on the passivation layer 180. Exemplary embodiments of these may be formed of a transparent conductive material such as ITO or IZO, or a reflective metal such as aluminum, silver, chromium, or an alloy thereof.

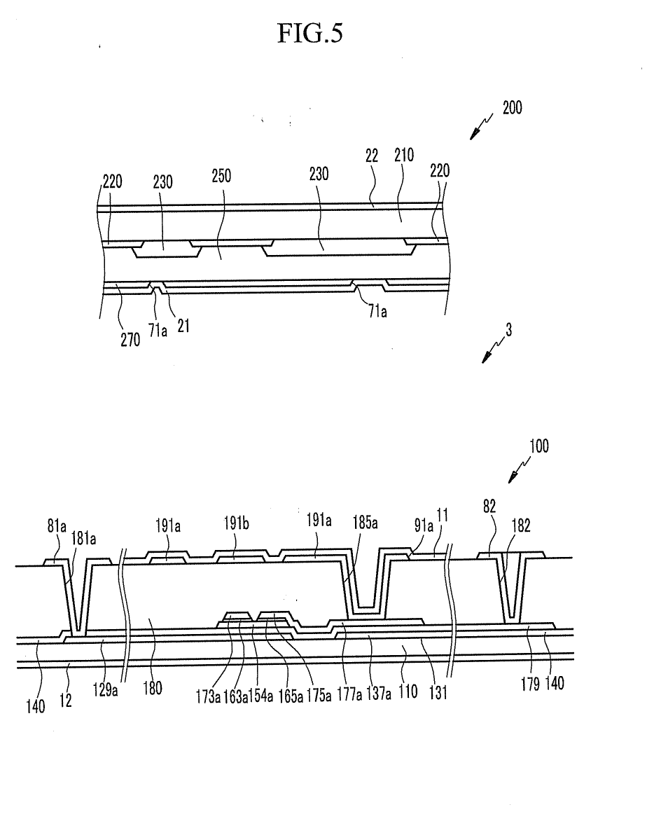

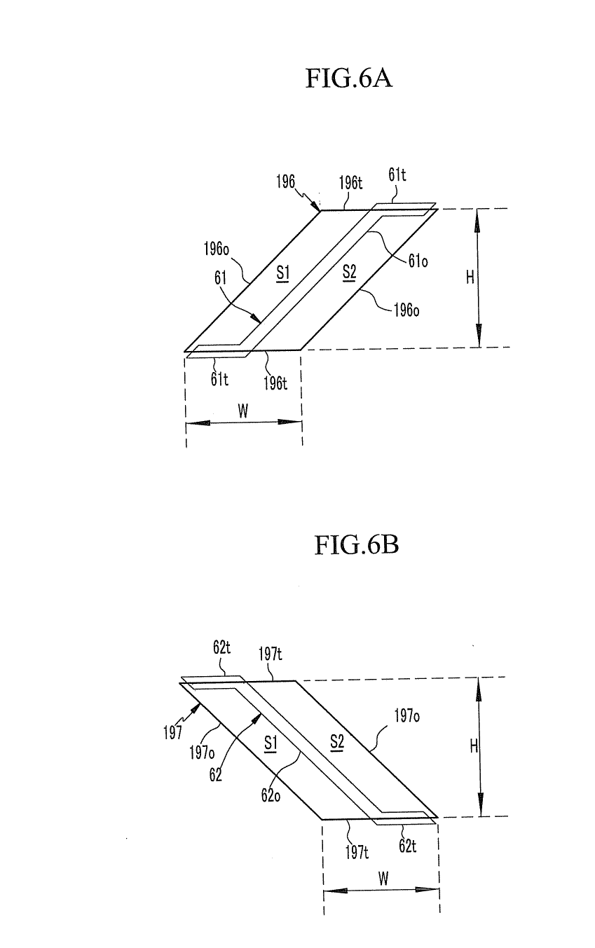

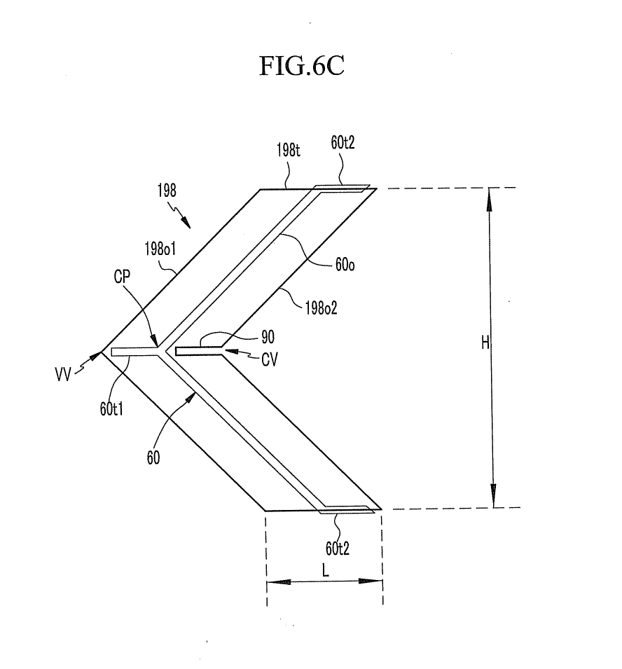

The detailed structures of exemplary embodiments of the pixel electrode and the common electrode in an exemplary embodiment of a liquid crystal panel assembly according to the present invention will be described with reference to FIGS. 6A to 6C and FIG. 4.

FIG. 6A, 6B and FIG. 6C are top plan views of exemplary embodiments of electrode pieces and a base electrode forming a subpixel electrode as shown in FIGS. 4 and 5.

In an exemplary embodiment of a liquid crystal panel assembly according to the present invention, each pixel electrode 191 includes a pair of first and second subpixel electrodes 191a and 191b which are separated from each other. The first subpixel electrode 191a and the second subpixel electrode 191b are adjacent to each other in a row direction, and have cutouts 91a and 91b, respectively. The common electrode 270 (see FIGS. 2 and 5) has cutouts 71a and 71b which face the first and second subpixel electrodes 191a and 191b, respectively.

Each of the first and second subpixel electrodes 191a and 191b includes at least one parallelogrammic electrode piece 196 as, shown in FIG. 6A and one parallelogrammic electrode piece 197 shown in FIG. 6B. If the electrode pieces 196 and 197 shown in FIGS. 6A and 6B are vertically connected to each other, a basis electrode 198 as shown in FIG. 6C is formed. Each of the subpixel electrodes 191a and 191b has a structure based on the base electrode 198.

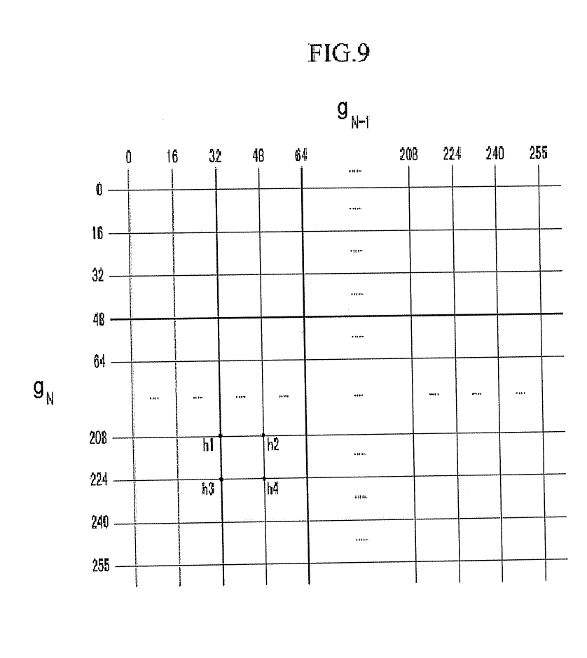

As shown in FIGS. 6A and 6B, each of the electrode pieces 196 and 197 has a shape of a parallelogram having a pair of oblique edges 196o and 197o and a pair of transverse edges 196t and 197t. Each of the oblique edges 196o and 197o makes an oblique angle with the transverse edges 196t and 197t, and the oblique angle ranges from about 45° to about 135°. For descriptive convenience, the electrode pieces 196 and 197 are classified into two types based on the inclination direction relative to a normal of the bottom edges 196t and 197t. The electrode piece 196 shown in FIG. 9A is referred to as “right-inclined” since it is inclined to right, while the electrode piece 197 shown in FIG. 9B is referred to as “left-inclined” since it is inclined to left.

The lengths of the transverse edges 196t and 197t in the electrode pieces 196 and 197, that is, a width (W), and a distance between the transverse edges 196t and 197t, that is, a height (H), can be freely determined according to the size of the liquid crystal panel assembly 300. The transverse edges 196t and 197t in the electrode pieces 196 and 197 may be modified, for example they may be curved or may be made to contain protrusions, in view of the relationship to other parts. Hereinafter, all the parallelogrammic pieces are referred to as a parallelogram.

As shown in FIGS. 6A-6C, the common electrode 270 has cutouts 61 and 62 which face the electrode pieces 196 and 197, and each of the electrode pieces 196 and 197 are partitioned into two sub-areas S1 and S2 by the cutouts 61 and 62, respectively. Each of the cutouts 61 and 62 include oblique portions 61o and 62o which are substantially in parallel with the oblique edges 196o and 197o of the electrode pieces 196 and 197, and transverse portions 61t and 62t which make an obtuse angle with respect to the oblique portions 61o and 62o and overlap the transverse edges 196t and 197t of the electrode pieces 196 and 197.

Each of the sub regions S1 and S2 has two primary edges which are defined by the oblique portions 61o and 62o of the cutouts 61 and 62 and the oblique edges 196o and 197o of the electrode pieces 196 and 197. According to one exemplary embodiment the distance between the primary edges, that is, a width of the sub-region, is in a range of about 25 μm to about 40 μm.

The base electrode 198 shown in FIG. 6C is formed by vertically combining the right-inclined electrode piece 196 and the left-inclined electrode piece 197.

In one exemplary embodiment the angle made by the right-inclined electrode piece 196 and the left-inclined electrode piece 197 is substantially equal to about a right angle, and the connection between the electrode pieces 196 and 197 is done only at some portions throughout a display area as seen in FIG. 4. In one exemplary embodiment the edge portions of the electrode pieces 196 and 197 are not connected to each other along their entire length, and a cutout 90 is disposed in a concavity therebetween. However, when the connection is done at substantially all portions of the electrode pieces 196 and 197, the cutout 90 may be omitted.

The outer transverse edges 196t and 197t of the two electrode pieces 196 and 197 form transverse edges 198t of the base electrode 198, and the oblique edges 196o and 197o of the two electrode pieces 196 and 197 are connected to each other to form curved edges 198o1 and 198o2 of the base electrode 198.

The curved edges 198o1 and 198o2 include a convex edge 198o1 which meets the transverse edge 198t at an obtuse angle, in one exemplary embodiment the angle is about 135°, and a concave edge 198o2 which meets the transverse edge 198t at an acute angle, in one exemplary embodiment the angle is about 45°. In one exemplary embodiment the curved edges 198o1 and 198o2 meet a pair of transverse edges 198t at approximately a right angle, and are curved at approximately a right angle.

The cutout 60 extends from a concave vertex CV on the concave edge 198o2 toward a convex vertex VV on the convex edge 198o1 until it reaches approximately to the center of the base electrode 198.

The cutouts 61 and 62 of the common electrode 270 are connected to each other to form one cutout 60. The overlapping transverse portions 61t and 62t in the cutouts 61 and 62 form one transverse portion 60t1. This new cutout 60 can be explained as follows.

The cutout 60 includes a curved portion 60o having a curved point CP, a central transverse portion 60t1 which is connected to the curved point CP of the curved portion 60o, and a pair of end transverse portions 60t2 which are connected to both ends of the curved portion 60o, respectively. The curved portion 60o of the cutout 60 is formed by a pair of oblique portions which meet at substantially a right angle, and which is substantially parallel with the curved edges 198o1 and 198o2 of the base electrode 198, and bisects the base electrode 198 into a left half portion and a right half portion. The central transverse portion 60t1 of the cutout 60 meets the curved portion 60o at an obtuse angle, in one exemplary embodiment the angle is about 135°, and substantially extends toward the convex vertex VV of the base electrode 198. The end transverse portions 60t2 are arranged with respect to the transverse edge 198t of the basis electrode 198 and meet the curved portion 60o at an obtuse angle, in one exemplary embodiment the angle is about 135°.

The base electrode 198 and the cutout 60 are approximately reverse symmetrical with respect to a virtual line (hereinafter, referred to “transverse center line”) between the convex vertex VV and the concave vertex CV of the basis electrode 198. In essence, the base electrode 198 and the cutout 60 exhibits mirror symmetry about the transverse center line.

In each exemplary embodiment of a pixel electrode 191 shown in FIG. 4, the size of the first subpixel electrode 191a is smaller than the size of the second subpixel electrode 191b. Particularly, the height of the second subpixel electrode 191b is greater than the height of the first subpixel electrode 191a, and the width of the second subpixel electrode 191b is also greater than the width of the first subpixel electrode 191a. The number of parallelogrammic electrode pieces of the second subpixel electrode 191b is larger than the number of parallelogrammic electrode pieces of the first subpixel electrode 191a.

The first subpixel electrode 191a has the left tilt electrode piece 197 and the right tilt electrode piece 196, and has substantially the same structure as the base electrode 198 shown in FIG. 6C.

The second subpixel electrode 191b has two or more left tilt electrode pieces 197 and two or more right tilt electrode pieces 196, and includes the base electrode 198 shown in FIG. 6C and the left tilt and right tilt electrode pieces 196 and 197 which are connected to the basis electrode 198.

The second subpixel electrode 191b has six electrode pieces, and of these, two electrode pieces are disposed above and below the first subpixel electrode 191a. Two of the other four electrode pieces form an intermediate electrode piece substantially the same size as the first subpixel electrode 191a. The last two pieces are disposed above and below the intermediate electrode piece. The pixel electrode 191b has a structure which is curved three times and has excellent vertical line expression capability compared with a structure which is curved once. At a position where the electrode piece of the first subpixel electrode 191a and the electrode piece of the second subpixel electrode 191b are adjacent to each other, the transverse portions 61t and 62t of the cutouts 61 and 62 of the common electrode 270 are put together so as to form one transverse portion, such that an aperture ratio further increases.

The intermediate electrode piece and the electrode pieces disposed above and below the intermediate electrode piece have different heights. For example, the heights of the upper and lower electrode pieces are about half of the height of the pieces which constitute the intermediate electrode piece. Accordingly, an area ratio between the first subpixel electrode 191a and the second subpixel electrode 191b becomes about 1:2. As such, a desired area ratio can be obtained by adjusting the heights of the upper and lower electrode pieces. In one exemplary embodiment, the area ratio ranges from approximately 1:1.1 to 1:3.

The storage electrode line 131, the wider end portions 177a and 177b of the drain electrode 175a and 175b, and the contact holes 185a and 185b are positioned on the transverse center line of the subpixel electrodes 191a and 191b. A line which connects the curved points of the subpixel electrodes 191a and 191b is located at a boundary of the above-described sub-regions. At this portion, the alignment of the liquid crystal molecules are scattered, and thus a texture appears. Therefore, with the above-described arrangement which includes cutouts and minimizes the positioning of curved points above display regions, it is possible to improve an aperture ratio while hiding the texture.

In one exemplary embodiment a length of the data line 171 which overlaps the first subpixel electrode 191a of one pixel electrode 191 may be equal to a length of the data line 171 which overlaps the second subpixel electrode 191b of an adjacent pixel electrode 191.

The first/second subpixel electrode 191a/191b is connected to the first/second drain electrode 175a/175b through the contact hole 185a/185b. The first/second subpixel electrode 191a/191b and the common electrode 270 of the upper display panel 200 form the first/second liquid crystal capacitor Clca/Clcb, together with the liquid crystal layer 3 interposed therebetween, and holds an applied voltage after the thin film transistor Qa/Qb is turned off.

The wider end portion 177a/177b of the first/second drain electrode 175a/175b which is connected to the first/second subpixel electrode 191a/191b overlaps the first/second storage electrode 137a/137b through the gate insulating layer 140 so as to form the first/second storage capacitor Csta/Cstb. The first/second storage capacitor Csta/Cstb reinforces voltage holding capability of the first/second liquid crystal capacitor Clca/Clcb.

The contact assistants 81a, 81b, and 82 are connected to the end portions 129a and 129b of the gate lines 121a and 121b and the end portion 179 of the data line 171 through the contact holes 181a, 181b, and 182, respectively. The contact assistants 81a, 81b, and 82 complement adhesion of the end portions 129a and 129b of the gate lines 121a and 121b and the end portion 179 of the data line 171 to an external device and protect them.

Next, the upper display panel 200 will be described.

A light blocking member 220 is formed on an insulation substrate 210. Exemplary embodiments of the insulation substrate may be formed of transparent glass or plastic. The light blocking member 220 includes a curved portion corresponding to the curved edge of the pixel electrode 191 and a quadrangle portion corresponding to the thin film transistor, blocks light leakage between the pixel electrodes 191, and defines an aperture region facing the pixel electrode 191.

A plurality of color filters 230 are formed on the substrate 210 and the light blocking member 220. Most of the color filter 230 exist in a region surrounded by the light blocking member 220, and extend along a column of pixel electrodes 191. According to one exemplary embodiment each color filter 230 can display one of three primary colors of red, green, and blue.

An overcoat 250 is formed on the color filter 230 and the light blocking member 220. The overcoat 250 may be formed of an organic or non-organic insulator. The overcoat 250 prevents the color filter 230 from being exposed and provides a planarized surface. In alternative exemplary embodiments the overcoat 250 may be omitted.

The common electrode 270 is formed on the overcoat 250. Exemplary embodiments of the common electrode 270 is formed of a transparent conductor, such as ITO or IZO, and have a plurality of cutouts 71a and 71b.

The shapes and arrangement of the cutouts 71a and 71b of the common electrode 270 have been described above, and thus a detailed description thereof will be omitted.

The number of cutouts 71a and 71b may vary according to design components. The light blocking member 220 may overlap the cutouts 71a and 71b to block light leakage in the vicinities of the cutouts 71a and 71b.

Alignment layers 11 and 21 are formed on the inner surfaces of the display panels 100 and 200. In one exemplary embodiment the alignment layers may be vertical alignment layers.

Polarizers 12 and 22 are provided on the outer surfaces of the display panels 100 and 200. The polarization axes of the two polarizers 12 and 22 are substantially perpendicular to each other. Preferably, one of the polarization axes is substantially parallel with the gate lines 121a and 121b. In an exemplary embodiment of the present invention utilizing a reflective liquid crystal display, one of the two polarizers 12 and 22 may be omitted.

A liquid crystal display may include the polarizers 12 and 22, a retardation film, the display panels 100 and 200, and a backlight unit (not shown) which supplies light to the liquid crystal layer 3.

In one exemplary embodiment the liquid crystal layer 3 has negative dielectric anisotropy, and liquid crystal molecules of the liquid crystal layer 3 may be aligned such that the major axes are vertical to the surfaces of the two display panels when an electric field is not applied.

In an alternative exemplary embodiment the cutouts 71a and 71b may be replaced with protrusions (not shown) or depressions (not shown). The protrusions may be formed of an organic material or an inorganic material and may be disposed above or below the field generating electrodes 191 and 270.

Referring again to FIG. 1, the gray voltage generator 800 generates a plurality of gray voltages related to the transmittance of the pixels PX. However, the gray voltage generator 800 may generate only a given number of gray voltages (referred to as reference gray voltages) instead of generating all of the gray voltages.

The gate driver 400 is connected to the gate line G₁ to Gₙ (not shown in FIG. 1, but shown in FIGS. 3-5) of the liquid crystal panel assembly 300 and applies gate signals obtained by combining a gate-on voltage Von and a gate-off voltage Voff to the gate lines G₁ to Gₙ.

The data driver 500 is connected to the data lines D₁ to Dₘ of the liquid crystal panel assembly 300 (not shown in FIG. 1, but shown in FIGS. 3-5), selects gray voltages from the gray voltage generator 800, and applies the selected gray voltages to the data line D₁ to Dₘ as the data signals. However, when the gray voltage generator 800 does not supply voltages for all gray levels, but supplies only a predetermined number of reference gray voltages, the data driver 500 divides the reference gray voltages, generates gray voltages for all the gray levels, and selects the data signals from among them.

The signal controller 600 controls the gate driver 400, the data driver 500, and the like.

According to one exemplary embodiment the driving devices 400, 500, 600, and 800 may be directly mounted on the liquid crystal panel assembly 300 as at least one integrated circuit (“IC”) chip or may be mounted on a flexible printed circuit film (“FPC”) (not shown) and attached to the liquid crystal panel assembly 300 as a tape carrier package (“TCP”). Further, each driving device may be mounted on a separate printed circuit board (“PCB”) (not shown). Further, each of the driving devices 400, 500, 600, and 800 may be integrated into the liquid crystal panel assembly 300, together with the signal lines G₁ to Gₙ and D₁ to Dₘ, the thin film transistor switching elements Q, and so on. In addition, the driving devices 400, 500, 600, and 800 may be integrated into a single chip. In this case, at least one of the driving devices 400, 500, 600, and 800 or at least one circuit element of the driving devices 400, 500, 600, and 800 may be provided outside the single chip.

The operation of the liquid crystal display will now be described in detail.

The signal controller 600 is supplied with input image signal R, G, and B and input control signals for controlling display thereof from an external graphics controller (not shown). The input image signal R, G, and B have luminance information of each pixel PX, and the luminance has a predetermined number of gray levels, for example, 1024 (=2¹⁰), 256 (=2⁸), or 64 (=2⁶). Examples of the input control signals include a vertical synchronizing signal Vsync, a horizontal synchronizing signal Hsync, a main clock signal MCLK, and a data enable signal DE.

After generating gate control signals CONT1 and data control signals CONT2 and processing the input image signals R, G and B suitable for the operation of the panel assembly 300 and the data driver 500 on the basis of the input control signals and the input image signals R, G and B, the signal controller 600 transmits the gate control signals CONT1 to the gate driver 400, and the processed image signals DAT and the data control signals CONT2 to the data driver 500. The output image signals DAT are digital signals having a predetermined number of values (or grays).

The gate control signal CONT1 includes a scanning start signal STV for instructing to start scanning and at least one clock signal for controlling an output cycle of the gate-on voltage Von. In one exemplary embodiment the gate control signal CONT1 may further include an output enable signal OE for defining the duration of the gate-on voltage Von.

The data control signal CONT2 includes a horizontal synchronization start signal STH for informing the start of transmission of the digital image signals DAT to one row of pixels PX, a load signal LOAD for instructing to apply analog data voltages to the data lines D₁ to Dₘ, and a data clock signal HCLK. The data control signal CONT2 may further include an inversion signal RVS for inverting the voltage polarity of the analog data voltage with respect to the common voltage Vcom (hereinafter, “the polarity of the data voltage with respect to the common voltage” is simply referred to as “the polarity of the data voltage”). The polarity of the data voltage may be inverted to extend the lifetime of the liquid crystal molecules. When liquid crystal molecules are continually twisted in only one orientation they wear more rapidly than if the orientation of rotation is cycled.

The data driver 500 receives the digital image signals DAT for a row of pixels PX according to the data control signal CONT2 from the signal controller 600, and selects the gray voltages corresponding to the digital image signals DAT. Then, the data driver 500 converts the digital image signals DAT into the analog data voltages, and applies the converted analog data voltages to the data lines D₁ to Dₘ.

The gate driver 400 applies the gate-on voltage Von to the gate lines G₁ to Gₙ according to the gate control signal CONT1 from the signal controller 600 and turns on the switching elements Q which are respectively connected to the gate lines G₁ to Gₙ. Then, the data voltages applied to the data lines D₁ to Dₘ are applied to the pixels PX through the turned-on switching elements Q.

A difference between the data voltage applied to the pixel PX and the common voltage Vcom becomes a charging voltage of the liquid crystal capacitor C_{LC}, that is, a pixel voltage. The degree of twisting of the liquid crystal molecules varies according to the magnitude of the pixel voltage, such that the polarization of light passing through the liquid crystal layer 3 may be varied accordingly. The change of the polarization causes a change in transmittance of light by the polarizer that is attached to the liquid crystal panel assembly 300. Then, the pixel PX displays luminance represented by the gray level of the image signal DAT.

This process is repeated for every one horizontal period, which is also called “1H” and is equal to one cycle of the horizontal synchronizing signal Hsync and the data enable signal DE. One cycle of the horizontal synchronizing signal Hsync is also called “one frame”. Then, the gate-on voltage Von is sequentially applied to all the gate lines G₁ to Gₙ, and the data voltages are applied to all the pixels PX, such that an image is displayed for one frame.

When the next frame starts after one frame is completed, the state of the inversion signal RVS applied to the data driver 500 is controlled such that the polarity of the data voltage applied to each pixel PX is inverted with respect to the polarity of the previous frame (“frame inversion”). At this time, in one frame the polarity of the data voltage which flows in a data line may be inverted (for example, row inversion and dot inversion) or the polarities of the data voltages which are applied to a row of pixels may vary (for example, column inversion and dot inversion), according to the characteristic of the inversion signal RVS. Again, this is done to extend the lifetime of the liquid crystal molecules.

Meanwhile, the voltage across the LC capacitor Clc1 or Clc2 forces the LC molecules in the LC layer 3 to reorient into a stable state corresponding to the voltage, and the reorientation of the LC molecules takes time since the response time of the LC molecules is relatively slow compared to the rate at which new frames are displayed (also known as the “frame rate”). The LC molecules continue to reorient themselves to vary the light transmittance (or the luminance) until they reach the stable state as long as the application of the voltage across the LC capacitor Clc1 or Clc2 is maintained. When the LC molecules reach the stable state and stop reorienting themselves to the applied voltage, the light transmittance becomes fixed.

When a pixel voltage in the stable state is referred to as “target pixel voltage”, and light transmittance at this time is referred to as “target light transmittance”, the target pixel voltage and the target light transmittance have a one-on-one correspondence relationship.

However, since the switching element Q of each pixel PX is turned on only for a brief time period and a time for applying the data voltage therefrom is limited, the liquid crystal molecules rarely reach the stable state during application of the data voltage. However, even though the switching element Q is turned off, a difference in voltage at both ends of the liquid crystal capacitor Clc still exists, and the liquid crystal molecules continue to move toward the stable state. As such, if the alignment state of the liquid crystal molecules changes, the dielectric constant of the liquid crystal layer 3 changes, and thus capacitance of the liquid crystal capacitor Clc changes. In a state where the switching element Q is turned off, one terminal of the liquid crystal capacitor Clc is in a floating state, meaning that a voltage measured thereat will fluctuate. Accordingly, if a leakage current is not taken into account, the total charges accumulated in the liquid crystal capacitor Clc are unchanged and remain constant. For this reason, a change in capacitance of the liquid crystal capacitor Clc is accompanied by a change in voltage between both ends of the liquid crystal capacitor Clc, that is, a change in pixel voltage.

Accordingly, if the data voltage (hereinafter, referred to as “target data voltage”) corresponding to the target pixel voltage on the basis of the stable state is applied to the pixel PX, an actual pixel voltage will be different from the target pixel voltage, and thus the target transmittance cannot be obtained. Particularly, as the target transmittance becomes increasingly different from the original transmittance of the pixel PX, a difference between the actual pixel voltage and the target pixel voltage becomes larger.

Therefore, it is necessary to make the data voltage to be applied to the pixel PX larger or smaller than the target data voltage. As one of methods thereof, a dynamic capacitance compensation (“DCC”) method is used.

In the present exemplary embodiment, DCC is performed in the signal controller 600 or a separate image signal correction unit. In DCC, a corrected current image signal (hereinafter, referred to as “first corrected image signal g_{N}′”) is generated by correcting an image signal (hereinafter, “current image signal g_{N}”) for one frame of an arbitrary pixel PX on the basis of an image signal (hereinafter, referred to as “previous image signal g_{N-1}”) for a previous frame of that pixel PX. The first corrected image signal g_{N}′ is basically determined by experimental results, and a difference between the first corrected image signal g_{N}′ and the previous image signal g_{N-1} is generally larger than a difference between the current image signal g_{N} before correction and the previous image signal g_{N-1}. However, when the current image signal g_{N} and the previous image signal g_{N-1} are the same or the difference between them is small, the first corrected image signal g_{N}′ may be equal to the current image signal g_{N} (that is, the correction may not be performed, or after correction there may be no difference between the corrected image signal g_{N}′ and the current image signal g_{N}).

Then, the first corrected image signal g_{N}′ can be expressed by the following function F1.
g_{N}′=F1(g_{N},g_{N-1}) Equation 1

In such a manner, the data voltage which is applied from the data driver 500 to each pixel PX is higher or lower than (or in rare instances, as described above, it may be substantially the same as) the target data voltage.

Table 1 shows examples of the first corrected image signal g_{N}′ for pairs of several previous image signals g_{N-1} and the current image signal g_{N} when the number of gray levels is 256.

In order to perform such an image signal correction, a storage space which stores the image signals g_{N-1} of the previous frame is required, and in one exemplary embodiment a frame memory serves as the storage space. Further, a lookup table which stores the relationship shown in Table 1 is required.

TABLE 1

| | | gN − 1 | | | | | | | | |
|---|---|---|---|---|---|---|---|---|---|---|
| | | 0 | 32 | 64 | 96 | 128 | 160 | 192 | 224 | 255 |
| gN | 0 | 0 | 0 | 0 | 0 | 0 | 0 | 0 | 0 | 0 |
| | 32 | 115 | 32 | 22 | 20 | 15 | 15 | 15 | 15 | 15 |
| | 64 | 169 | 103 | 64 | 50 | 34 | 27 | 22 | 20 | 16 |
| | 96 | 192 | 146 | 118 | 96 | 87 | 70 | 54 | 36 | 29 |
| | 128 | 213 | 167 | 156 | 143 | 128 | 121 | 105 | 91 | 70 |
| | 160 | 230 | 197 | 184 | 179 | 174 | 160 | 157 | 147 | 129 |
| | 192 | 238 | 221 | 214 | 211 | 205 | 199 | 192 | 187 | 182 |
| | 224 | 250 | 245 | 241 | 240 | 238 | 238 | 224 | 224 | 222 |
| | 255 | 255 | 255 | 255 | 255 | 255 | 255 | 255 | 255 | 255 |

In order to store the first corrected image signals g_{N}′ for all the pairs of the current and previous image signals g_{N-1} and g_{N}, the size of the lookup table needs to be relatively large. Therefore, in one exemplary embodiment the first corrected image signal g_{N}′ is stored as a reference corrected image signal for the pairs of the previous and current image signals g_{N-1} and g_{N} shown in Table 1, and the pairs of the remaining previous and current image signals g_{N-1} and g_{N} are calculated by an interpolation method to calculate the first corrected image signal g_{N}′. The interpolation for a pair of arbitrary previous and current image signals g_{N-1} and g_{N} is performed by calculating the first corrected image signal g_{N}′ for the pair of the image signals g_{N-1} and g_{N} on the basis of the reference corrected image signals for the pair of the image signals g_{N-1} and g_{N} close to the pair of the image signals g_{N-1} and g_{N} from Table 1.

In one exemplary embodiment, the image signal, which is a digital signal, is divided into upper bits and lower bits, and the reference corrected image signal for the pair of the previous image signal having the lower bits of 0 and the current image signal g_{N-1} and g_{N} is stored in the lookup table. The associated reference corrected image signals for a pair of arbitrary previous and current image signals g_{N-1} and g_{N} are found from the lookup table on the basis of the upper bits, and then the first corrected image signal g_{N}′ is calculated using the lower bits of the previous and current image signals (g_{N-1}, g_{N}) and the reference corrected image signal found from the lookup table.

However, even though such an exemplary embodiment of a method is used, it may be difficult to obtain the target transmittance. When such problems occur, another exemplary embodiment of a method which applies an intermediate voltage in the previous frame in advance, then causes the liquid crystal molecules to tilt in advance (referred to as “pretilt”), and subsequently applies the voltage in the current frame again, is used.

In such an exemplary embodiment when correcting the image signal g_{N} of the current frame, the signal controller 600 or the image signal correction unit generates the corrected current image signal (hereinafter, referred to as “second corrected image signal g_{N}″”) in view of the image signal g_{N-1} of the previous frame and an image signal (hereinafter, referred to as “next image signal g_{N+1}”) of the next frame. For example, if the current image signal g_{N} is equal to the previous image signal g_{N-1}, but a difference between the next image signal g_{N+1} and the current image signal g_{N} is large, the current image signal g_{N} is corrected for the next frame. In this exemplary embodiment, the second corrected image signal g_{N}″ can be expressed by the following function F2. Here, a frame memory which stores the previous image signal g_{N-1} and the current image signal g_{N}, and a lookup table which stores the corrected image signal for the pair of the previous and current image signals g_{N-1} and g_{N} are required. In some alternative exemplary embodiments, a lookup table which stores a corrected image signal for the pair of the current and next image signals g_{N} and g_{N+1} may be required.
g_{N}″=F2(g_{N}′,g_{N+1}) Equation 2

The correction of the image signal and the data voltage may not be performed or may be performed on the maximum gray level or the minimum gray level among the gray levels to be represented by the image signal. In order to perform the correction on the maximum gray level or the minimum gray level, a method which causes a range of gray voltages to be generated by the gray voltage generator 800 which is wider than a range of the target data voltage required for obtaining a target luminance range (or a target transmittance range) to be represented by the gray levels of the image signal is used. In other words, if correction is to be applied to either the maximum or the minimum gray levels then the voltage generator 800 must be able to supply a greater range of voltages than the range of possible target data voltages.

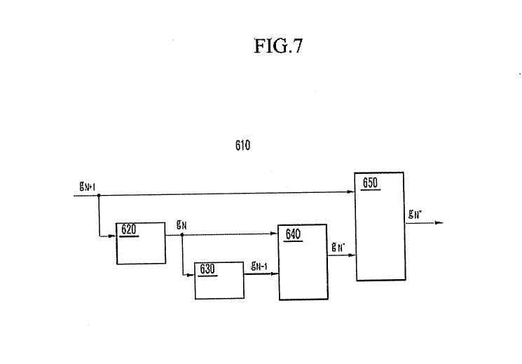

An exemplary embodiment of an image signal correction unit of a liquid crystal display according to the present invention in order to implement the image signal correction will be described in detail with reference to FIGS. 7 to 9.

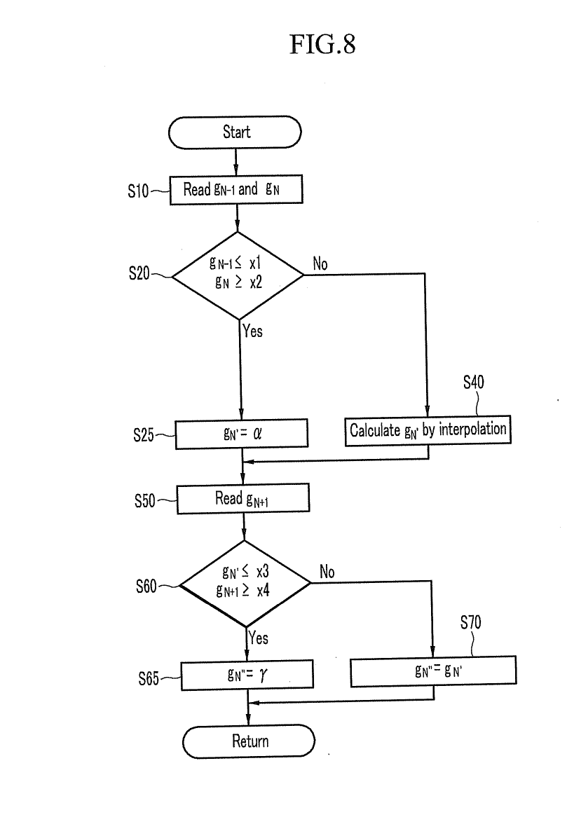

FIG. 7 is a block diagram of an exemplary embodiment of an image signal correction unit of an exemplary embodiment of a liquid crystal display according to the present invention, FIG. 8 is a flow chart showing an example of the operation of the exemplary embodiment of an image signal correction unit shown in FIG. 7, and FIG. 9 is a schematic view illustrating an exemplary embodiment of an image signal correction method according to the present invention.

As shown in FIG. 7, an exemplary embodiment of an image signal correction unit 610 according to the present invention includes a first memory 620 which is connected to the next image signal g_{N+1}, a second memory 630 which is connected to the first memory 620, a first correction unit 640 which is connected to the first and second memories 620 and 630, and a second correction unit 650 which is connected to the first correction unit 640 and the next image signal g_{N+1}. Exemplary embodiments of the image signal correction unit 610 may be entirely or partially included in the signal controller 600 shown in FIG. 1, or alternative exemplary embodiments include configurations wherein it may be implemented as a separate device.

The first memory 620 sends the stored current image signal g_{N} to the second memory 630 and the first correction unit 640, and receives an input next image signal g_{N+1} and stores it for use as a current image signal of the next frame.

The second memory 630 sends the stored previous image signal g_{N-1} to the first correction unit 640, and receives the current image signal g_{N} from the first memory 620 and stores it for use as a previous image signal of the next frame.

In the present exemplary embodiment the first memory 620 and the second memory 630 are separated from each other, but alternative exemplary embodiments include configurations wherein one memory can send the stored previous image signal g_{N-1} and current image signal g_{N} to the first correction unit 640, and receive and store the input next image signal g_{N+1}.

The first correction unit 640 includes a lookup table (not shown). The first correction unit 640 calculates a first corrected image signal g_{N}′ on the basis of the previous image signal g_{N-1} from the second memory 630 and the current image signal g_{N} from the first memory 620 and sends the generated first corrected image signal g_{N}′to the second correction unit 650. Here, as described above, the lookup table stores the reference corrected image signal for the previous image signal g_{N-1} and the current image signal g_{N}.

The second correction unit 650 calculates and outputs a second corrected image signal g_{N}″ on the basis of the next image signal g_{N+1} and the first corrected image signal g_{N}′ from the first correction unit 640.

The operations of the first and second correction units 640 and 650 will now be described in detail.

As shown in FIG. 8, first, if the operation starts, the first correction unit 640 reads the previous image signal g_{N-1} and the current image signal g_{N} from the first and second memories 620 and 630, respectively (step S10).

Then, the first correction unit 640 compares the previous image signal g_{N-1} and a predetermined value x1, and compares the current image signal g_{N} and a predetermined value x2 (step S20).

At step S20, as the comparison result, if the previous image signal g_{N-1} is equal to or less than the predetermined value x1 and the current image signal g_{N} is equal to or more than the predetermined value x2, the first corrected image signal g_{N}′ is set to have a correction value α (step S25).

Here, the predetermined value x1 is an upper threshold value of the previous image signal g_{N-1} for an overshoot voltage, and the predetermined value x2 is a lower threshold value of the current image signal g_{N} for an overshoot voltage. The correction value α is an upper limit value of the image signal. For example, when the image signal has 8 bits, the correction value is “255” or “0”. Hereinafter, for purposes of explanation it is assumed that the image signal has 8 bits. However, exemplary embodiments of the image signal may include larger or smaller numbers of bits.

The correction value “255” corresponds to a voltage (hereinafter, referred to as “overshoot voltage”) which is higher than the highest target data voltage, and the correction value “0” corresponds to a voltage (hereinafter, referred to as “undershoot voltage”) which is lower than the lowest target data voltage. The overshoot voltage and the undershoot voltage are upper limit and lower limit voltages which can be generated by the gray voltage generator 800, respectively. In order to apply the overshoot voltage and the undershoot voltage, the signal controller 600 reduces a range of the input image signal in advance because of the color correction process for making colors by changing the gray level of three primary colors. That is, the input image signal has a data value of 0 to 255 or is converted to have a data value of 1 to 254 through color correction. The converted data “1” corresponds to the lowest target data voltage, and the converted data “254” corresponds to the highest target data voltage. In the exemplary embodiment wherein the liquid crystal display is a normally black mode liquid crystal display, the converted data “1” corresponds to a black gray level, and the converted data “254” corresponds to a white gray level. In the exemplary embodiment wherein the liquid crystal display is a normally white mode liquid crystal display, the converted data “1” corresponds to a white gray level, and the converted data “254” corresponds to a black gray level. Hereinafter, it is assumed that the liquid crystal display is a normally black mode type.

If the comparison result of step S20 determines that the previous image signal g_{N-1} is not equal to or less than the predetermined value x1 or the current image signal g_{N} is not equal to or more than the predetermined value x2, then step S25 is skipped and instead G_{N′} is calculated by interpolation (step S40). In the interpolation step 540 a plurality of reference corrected image signals corresponding to the pair of the read previous and current image signals g_{N-1} and g_{N} are extracted from the lookup table, and the first corrected image signal g_{N}′ is calculated using an interpolation method, together with the previous image signal g_{N-1} and the current image signal g_{N}.

Referring to FIG. 9, the reference corrected image signals for 17×17 combinations of the previous and current image signals g_{N-1} and g_{N} in 16 gray units are stored in the lookup table. If the pair of the previous and current image signals g_{N-1} and g_{N} is (36, 218), the first correction unit 640 extracts the reference corrected image signals h1, h2, h3, and h4 for the pairs of the previous and current image signals (32, 208), (48, 208), (32, 224), and (48, 224) from the lookup table, performs linear interpolation on the basis thereof, and calculates the first corrected image signal g_{N}′. The reference corrected image signals are determined in advance through experimentation or other similar methods.

The second correction unit 650 reads the next image signal g_{N+1} (step S50).

The second correction unit 650 compares the first corrected image signal g_{N}′ of the first correction unit 640 and a predetermined value x3, and compares the next image signal g_{N+1} and a predetermined value x4 (step S60).

At step S60 if the first corrected image signal g_{N}′ is equal to or less than the predetermined value x3, and the next image signal g_{N+1} is equal to or more than the predetermined value x4, the second corrected image signal g_{N}″ is set to have a correction value γ (step S65).

If the comparison result determines that the first image signal g_{N}′ is not equal to or less than the predetermined value x3 or the next image signal g_{N+1} is not equal to or more than the predetermined value x4, step S65 is avoided, and instead the second corrected image signal g_{N}″ is allowed to have the same value as the first corrected image signal g_{N}′ (step S70).

As such, the second corrected image signal g_{N}″ is determined and then the operation is repeated for the next set of image signals.

Here, the correction value γ is larger than the first corrected image signal g_{N}′ and is provided for the pretilt of the liquid crystal. The predetermined value x3 is an upper threshold value of the first corrected image signal g_{N}′ for the pretilt, and the predetermined value x4 is a lower threshold value of the next image signal g_{N+1} for the pretilt.

The predetermined values x1 to x4 and the correction value γ may vary depending on the characteristics of the liquid crystal display and design components, and may be determined through experimentation or various other strategies.

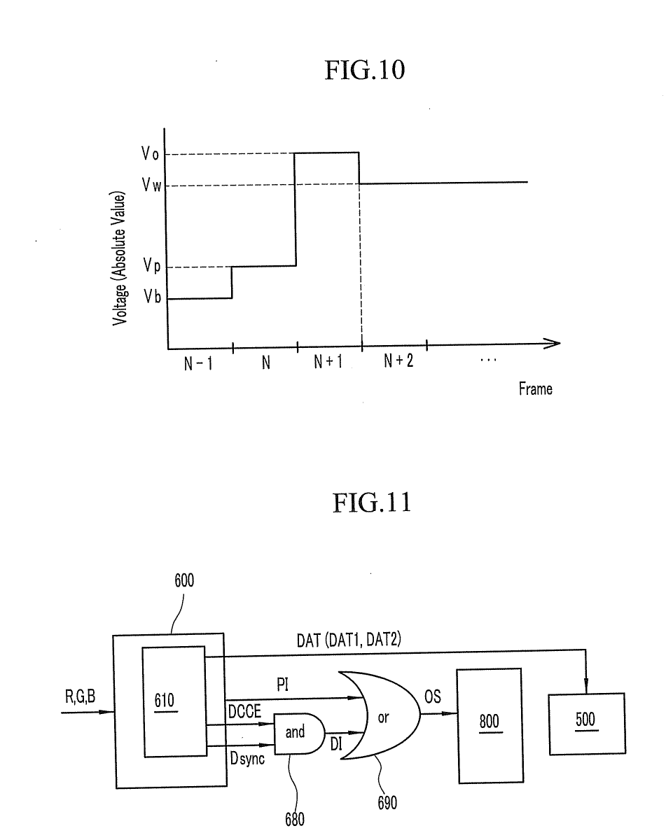

An example where the exemplary embodiment of an image signal correction unit 610 according to the present invention generates the second corrected image signal g_{N}″ for the input image signal will now be described with reference to FIG. 10.

FIG. 10 is a waveform chart showing an exemplary embodiment of a corrected signal according to the present invention.

In the waveform chart of FIG. 10, the horizontal axis represents the number of frames, and the vertical axis represents a pixel voltage as an absolute value.

The waveform chart of FIG. 10 is a waveform chart in a case where the overshoot voltage is applied. As described above, the upper limit of the pixel voltage is the overshoot voltage Vo.

Here, since the pixel voltage corresponds to an image signal represented by a gray level one-on-one, for better comprehension and ease of description, the pixel voltage and the image signal are used together. Further, it is assumed that the pixel voltages corresponding to the black and white gray levels are a black voltage Vb and a white voltage Vw.

It is assumed that the input image signal has a black gray level in the (N−1)-th and N-th frames and has a white gray level in the (N+1)-th and (N+2)-th frames.

The first correction unit 640 sets the first corrected image signal of the (N+1)-th frame as the overshoot voltage Vo according to a difference of the input image signals in the N-th and (N+1)-th frames. Then, since the input image signals of the N-th and (N+2)-th frames are the same as the input image signals of the previous frame, respectively, the first corrected image signals of the N-th and (N+2)-th frame are set to the same values of the input image signals.

The second correction unit 650 sets the second corrected image signal of the N-th frame satisfying the condition of step S60 as the correction value γ corresponding to a pretilt voltage Vp, and sets the second corrected image signals of other remaining frames to the same values as the first corrected image signals of those frames.

Then, the output second corrected image signals become sequentially the black voltage Vb in frame N−1, the pretilt voltage Vp in frame N, the overshoot voltage Vo in frame N+1, and the white voltage Vw in frame N+2.

As such, if the second corrected image signal is applied to the pixel as the pretilt voltage Vp in the N-th frame, the liquid crystal is pretilted, and thus it is possible to more rapidly approach the target light transmittance for the white voltage Vw in the (N+1)-th frame because the liquid crystal molecules have already begun twisting in that direction.

An exemplary embodiment of a driving apparatus and an exemplary embodiment of a driving method of an exemplary embodiment of a liquid crystal display including such an image signal correction unit will now be described with reference to FIGS. 11 to 13.

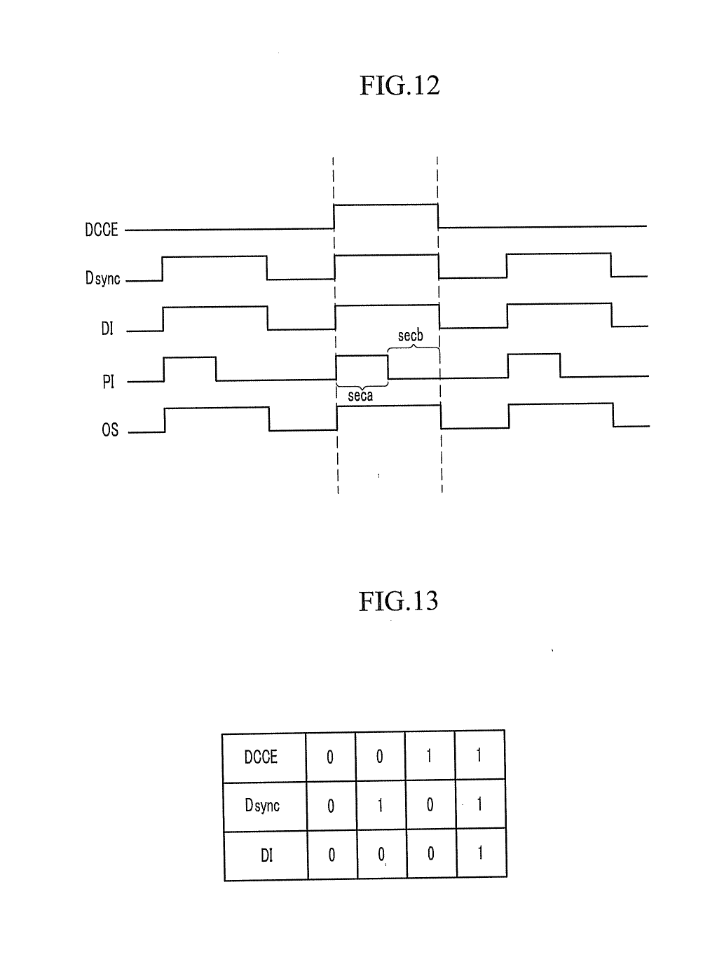

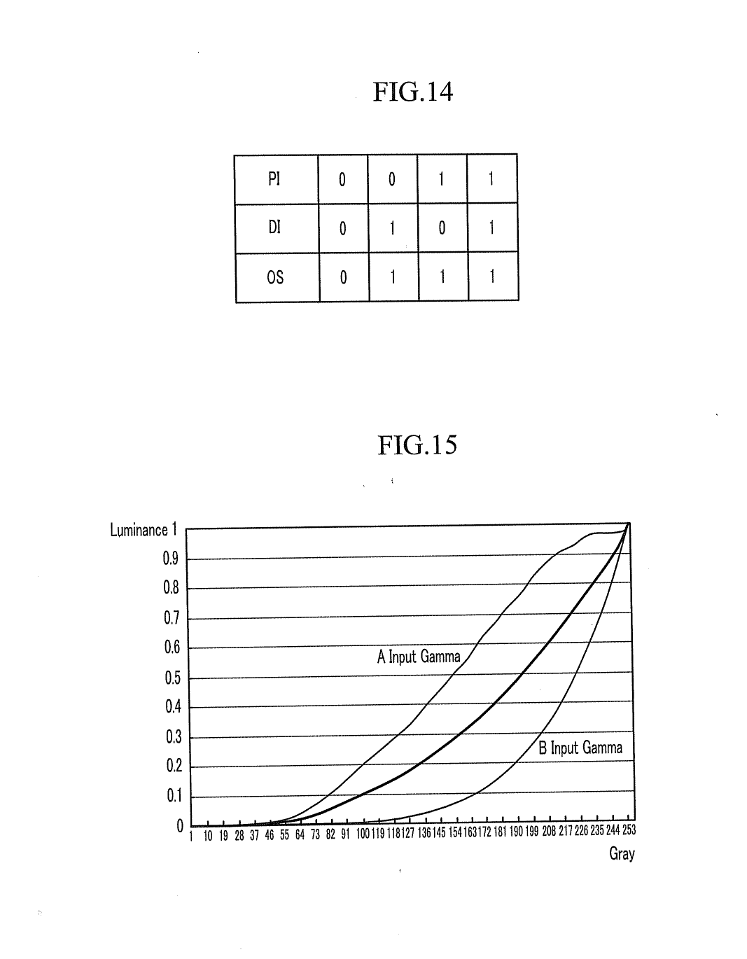

FIG. 11 is a block diagram showing an exemplary embodiment of a driving apparatus for an exemplary embodiment of a liquid crystal display according to the present invention. FIG. 12 is a diagram showing waveforms of an exemplary embodiment of a driving signal in an exemplary embodiment of a liquid crystal display according to the present invention, FIGS. 13 and 14 are diagrams showing the operations of exemplary embodiments of a logical AND circuit and an exemplary embodiment of a logical OR circuit in the exemplary embodiment of a driving apparatus of an exemplary embodiment of a liquid crystal display shown in FIG. 11, and FIG. 15 is a graph showing a change in luminance according to gray levels in an exemplary embodiment of a liquid crystal display according to the present invention.

Referring to FIGS. 11 and 12, an exemplary embodiment of a driving apparatus for a liquid crystal display according to the present invention includes an image signal correction unit 610, a logical AND circuit 680 which is connected to the image signal correction unit 610, a logical OR circuit 690 which is connected to a logical AND circuit 680, a gray voltage generator 800 which is connected to the logical OR circuit 690, and a data driver 500 which is connected to the image signal correction unit 610 and the gray voltage generator 800.

As described above, the image signal correction unit 610 corrects the current image signal on the basis of the previous image signal and the next image signal, and transmits the corrected image signal to the data driver 500. In one exemplary embodiment the image signal correction unit 610 may be included in the signal controller 600. At this time, the output image signals DAT which are output from the signal controller 600 include a normal image signal DAT1, that is, the input image signal which is input to the image signal correction unit 610 but is output as it is without being subject to the correction procedure, and a corrected image signal DAT2 which is output after being subject to the correction procedure in the image signal correction unit 610.

The image signal correction unit 610 generates an enable signal DCCE of the corrected image signal and a synchronization signal Dsync, as well as the corrected image signal.

The enable signal DCCE of the corrected image signal is a signal which allows the first corrected image signal obtained by correcting the current image signal to be output when the difference between the previous image signal and the current image signal is equal to or more than a predetermined value, or allows the second corrected image signal obtained by correcting the first corrected image signal to be output when the difference between the first corrected image signal and the next image signal is equal to or more than a predetermined value. When the enable signal DCCE of the corrected image signal has a digital of “1”, the corrected image signal is applied. When the enable signal DCCE is “0”, the corrected image signal is not applied, as in instances where correction is not required. In FIG. 12, if the signal is in the high level, the digital value is “1”, and if the signal is in the low level, the digital value is “0”. Therefore, in a period where the enable signal DCCE of the corrected image signal is in the high level, the digital value is “1”, and in a period where the enable signal DCCE is in the low level, the digital value is “0”.

The synchronization signal Dsync of the corrected image signal is a signal which informs of a time at which the corrected image signal is applied. As shown in FIG. 10, the time at which the corrected image signal is applied is the (N+1)-th frame where the overshoot voltage Vo is applied according to the first corrected image signal and the N-th frame where the pretilt voltage Vp is applied according to the second corrected image signal. The synchronization signal Dsync also has a digital value. The digital value “1” refers to the time at which the corrected image signal is applied, and the digital value “0” refers to a time at which the corrected image signal is not applied. A period where the synchronization signal is “1” may be a period of one frame or two frames.

The logical AND circuit 680 receives the enable signal DCCE and the synchronization signal Dsync of the corrected image signal, calculates a logical product thereof, and outputs the logical product as a corrected information signal DI. Therefore, as shown in FIG. 13, when both the enable signal DCCE and the synchronization signal Dsync of the corrected image signal are “0”, when the enable signal DCCE is “0” and the synchronization signal Dsync is “1”, and when the enable signal DCCE is “1” and the synchronization signal Dsync is “0”, the corrected information signal DI is “0”. Only when both the enable signal DCCE and the synchronization signal Dsync are “1” does corrected information signal DI becomes “1”.

The logical OR circuit 690 receives the corrected information signal DI output from the logical AND circuit 680 and a pixel information signal PI from the signal controller 600, calculates a logical sum thereof, and outputs the logical sum as a result signal OS.

The pixel information signal PI is a signal which determines to which subpixel the data voltage corresponding to the normal image signal DAT1 or the corrected image signal DAT2 is applied. When a subpixel charged with the data voltage is the first subpixel PXa, the pixel information signal PI is “1”, and when a subpixel charged with the data voltage is the second subpixel PXb, the pixel information signal PI is “0”.

The selection signal SE, which is output from the signal controller 600 to the gray voltage generator 800, can be used as the pixel information signal PI. The selection signal SE is a signal which controls an analog switch to select one of two reference gray voltage sets generated by the gray voltage generator 800 and to send the selected set. In FIG. 12, in a first period seca, the first subpixel is selected, and in a second period secb, the second subpixel is selected.

As shown in FIG. 14, when both the pixel information signal PI and the corrected information signal DI are “0”, the logical OR circuit 690 outputs the selection signal SE of “0”. Meanwhile, when the pixel information signal PI is “0” and the corrected information signal DI is “1”, when the pixel information signal PI is “1” and the corrected information signal DI is “0”, and when both the pixel information signal PI and the corrected information signal DI are “1”, the logical OR circuit 690 outputs the selection signal SE of “1”.

The result signal OS which is output from the logical OR circuit 690 is applied to the gray voltage generator 800. The gray voltage generator 800 generates the first gray voltage set or the second gray voltage set according to the result signal OS. The first gray voltage set has a voltage which is higher than the second gray voltage set at the same gray level.

For example, when the result signal OS is “1”, the gray voltage generator 800 generates the first gray voltage set, and when the result signal OS is “0”, the gray voltage generator 800 generates the second gray voltage set. The gray voltage set generated by the gray voltage generator 800 is applied to the data driver 500. As described above, the data driver 500 selects the gray voltage corresponding to the output image signal DAT applied from the signal controller 600, converts the digital image signal DAT into an analog data voltage Vd, and applies the converted analog data voltage Vd to the corresponding data line.

In such a driving apparatus for an exemplary embodiment of a liquid crystal display according to the present invention, when the data voltage corresponding to the corrected image signal is applied to the second subpixel, a predetermined gray voltage is selected from the first gray voltage set having a relatively high voltage data voltage and is applied as the data voltage. That is, in the (N+1)th frame where the overshoot voltage Vo of FIG. 10 is applied or in the N-th frame where the pretilt voltage Vp is applied, the same data voltage as that of the first subpixel is applied to the second subpixel.

As shown in FIG. 15, in the second subpixel, to which the data voltage is applied according to a second gamma curve (B input gamma), particularly, a voltage change ratio per a predetermined change in gray level is small at a low gray level. Accordingly, when the data voltage corresponding to the corrected image signal is applied, the effects of the correction are not readily apparent. Therefore, as described above, when the data voltage corresponding to the corrected image signal is applied to the second subpixel, the data voltage to be applied to the second subpixel is preferably made to be the same as the first subpixel, to which the data voltage is applied, according to a first gamma curve (A input gamma), such that the effects of the correction can also be shown in the second subpixel.

In FIG. 11, the logical AND circuit 680 and the logical OR circuit 690 are independently shown, but in an alternative exemplary embodiment they may be included in the signal controller 600 or the gray voltage generator 800.

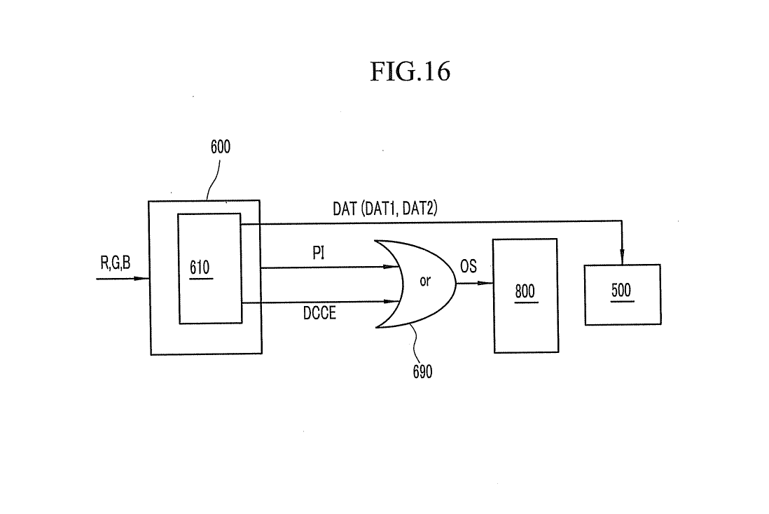

Another exemplary embodiment of a driving apparatus for an exemplary embodiment of a liquid crystal display according to the present invention will now be described with reference to FIG. 16.

FIG. 16 is a block diagram schematically showing another exemplary embodiment of a driving apparatus for an exemplary embodiment of a liquid crystal display according to the present invention.

Referring to FIG. 16, a driving apparatus according to the present exemplary embodiment includes a signal controller 600 which has image signal correction unit 610, a logical OR circuit 690 which is connected to the signal controller 600, a gray voltage generator 800 which is connected to the logical OR circuit 680, and a data driver 500 which is connected to the signal controller 600 and the gray voltage generator 800.

That is, in the exemplary embodiment of a driving apparatus of FIG. 16, unlike the driving apparatus of FIG. 11, a logical AND circuit is not provided, and the enable signal DCCE of the corrected image signal is directly input to the logical OR circuit 690 together with the pixel information signal PI. Like the driving apparatus of FIG. 11, a result signal OS output from the logical OR circuit 690 is input to the gray voltage generator 800.

According to the exemplary embodiment of a driving apparatus of FIG. 16, in the absence of noise causing an erroneous operation, other than the enable signal DCCE of the corrected image signal, in a liquid crystal display including two subpixels, it is possible to allow the effects of the image signal correction to be sufficiently shown.

According to the present invention, even in the second subpixel which follows the gamma curve having a small voltage change ratio at the low gray level, it is possible to allow the effects of the image signal correction to be shown, and thus it is possible to improve side visibility and increase a response speed of liquid crystal. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a plurality of pixels which have first and second subpixels respectively;
an image signal correction unit which generates a preliminary signal based on a previous image signal and a current image signal, generates a corrected image signal based on the preliminary signal and a next image signal, and generates an enable signal and a synchronization signal;
a first circuit which calculates a logical product of the enable signal and the synchronization signal and outputs the logical product as a corrected information signal;
a second circuit which calculates a logical sum of the corrected information signal and a pixel information signal and outputs the logical sum as a result signal; and
a gray voltage generator which generates first or second gray voltage sets which differ from each other,
wherein the corrected image signal is applied to the plurality of pixels when the enable signal is “1” and the corrected image signal is not applied to the plurality of pixels when the enable signal is “0”,
the corrected image signal is applied to the plurality of pixels when the synchronization signal is “1” and the corrected image signal is not applied to the plurality of pixels when the synchronization signal is “0”,
the corrected image signal is applied to the first subpixels when the pixel information signal is “1” and the corrected image signal is applied to the second subpixels when the pixel information signal is “0”,
the first gray voltage set is selected when the result signal is “1”, and, the second gray voltage set is selected when the result signal is “0”, and
the first gray voltage set has a higher potential than the second gray voltage set at substantially the same gray.

2. The liquid crystal display of claim 1, further comprising:
a data driver which selects a gray voltage from the gray voltage generator, changes the corrected image signal to a data voltage, and applies the data voltage to one of the first subpixel and the second subpixel.

3. The liquid crystal display of claim 1, wherein the first subpixel comprises a first thin film transistor, and the second subpixel comprises a second thin film transistor.

4. The liquid crystal display of claim 3, further comprising:
a first gate line connected to the first thin film transistor;
a second gate line connected to the second thin film transistor; and
a data line connected to the first and second thin film transistors.

5. The liquid crystal display of claim 1, wherein the pixel information signal is applied from a signal controller and comprises a selection signal SE which is applied to the gray voltage generator.

6. The liquid crystal display of claim 1, wherein a difference between the preliminary signal and the previous image signal is equal to or greater than a difference between the current image signal and the previous image signal.

7. The liquid crystal display of claim 1, wherein the image signal correction unit comprises:
a first frame memory which stores the previous image signal and a second frame memory which stores the current image signal; and
a lookup table which stores a reference preliminary signal which is based on the previous image signal and the current image signal.

8. The liquid crystal display of claim 7, wherein the first frame memory and the second frame memory are formed as a singular frame memory.

9. The liquid crystal display of claim 7, wherein the image signal correction unit interpolates the reference preliminary signal and generates the preliminary signal based on the interpolation of the reference preliminary signal.

10. The liquid crystal display of claim 1, wherein a period in which the synchronization signal is “1” is one or two frames.

11. The liquid crystal display of claim 1, wherein an area of the first subpixel is smaller than an area of the second subpixel.

12. The liquid crystal display of claim 1, wherein a data voltage applied to the first subpixel is higher than a data voltage applied to the second subpixel.

13. An image signal correction method of a liquid crystal display including first and second subpixels, the image signal correction method comprising:
generating a preliminary signal on the basis of a previous image signal and a current image signal, and generating a corrected image signal on the basis of the preliminary signal and a next image signal;
generating a synchronization signal which synchronizes an enable signal of the corrected image signal and the corrected image signal;
calculating a logical product of the enable signal and the synchronization signal to generate a corrected information signal;
calculating a logical sum of the corrected information signal and a pixel information signal to generate a result signal; and
generating a first gray voltage set or a second gray voltage set according to the result signal,
wherein the corrected image signal is applied when the enable signal is “1” and the corrected image signal is not applied when the enable signal is “0”,
the corrected image signal is applied when the synchronization signal is “1” and the corrected image signal is not applied when the synchronization signal is “0”,
the corrected image signal is applied to the first subpixel when the information signal is “1” and the corrected image signal is applied to the second subpixel when the information signal is “0”,
the first gray voltage set is selected when the result signal is “1”, and the second gray voltage set is selected when the result signal is “0”, and
the first gray voltage set has a higher potential than the second gray voltage set at substantially the same gray.

14. The image signal correction method of claim 13, wherein a period in which the synchronization signal is “1” is one or two frames.

15. A method of driving a liquid crystal display including first and second subpixels, the method comprising:
comparing a previous image signal, a current image signal, and a next image signal, and generating and outputting a corrected image signal according to the comparison result;
comparing the previous image signal, the current image signal, and the next image signal and outputting the current image signal according to the comparison result;
generating a first data voltage and a second data voltage corresponding to the corrected image signal when the corrected image signal is output;
generating a third data voltage and a fourth data voltage corresponding to the current image signal when the current image signal is output;
applying the first data voltage to the first subpixel and the second subpixel when the corrected image signal is output; and
applying the third data voltage to the first subpixel and applying the fourth data voltage to the second subpixel when the current image signal is output.

16. The method of claim 15, wherein a period in which the corrected image signal is output is one or two frames.

17. The method of claim 15, wherein the first data voltage is higher than the second data voltage and the third data voltage is higher than the fourth data voltage.

18. The method of claim 15, wherein an area of the first subpixel is smaller than an area of the second subpixel.

19. The method of claim 15, wherein the first subpixel comprises a first thin film transistor and the second subpixel comprises a second thin film transistor.

20. The method of claim 19, wherein the liquid crystal display comprises:
a first gate line connected to the first thin film transistor,
a second gate line connected to the second thin film transistor, and
a data line connected to the first and second thin film transistors.
